(19) United States
(12) Patent Application Publication
(10) Pub. No.: US 2011/0006615 A1
(43) Pub. Date: Jan. 13, 2011

(54) PLUG SOCKET

(76) Inventors: Sun Young Kim, Kyunggi-do (KR); Ki Chool Yang, Kyunggi-do (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/919,385

(22) PCT Filed: Feb. 27, 2009
(86) PCT No.: PCT/KR09/00938

§ 371 Date: Aug. 25, 2010

(30) Foreign Application Priority Data
Feb. 29, 2008 (KR) 10-2008-0019163

(51) Int. Cl. H02J 3/00

(52) U.S. Cl. 307/131; 307/116

(57) ABSTRACT

Provided is a plug socket which determines operation states of a plurality of electrical devices connected to the plug socket to supply or cut off electric power to the electrical devices and selects a method for supplying or cutting off electric power to the electrical devices by setting a desired mode. Thus, it is possible to prevent the waste of energy and electrical accidents by cutting off the electric power when the electrical devices connected to the plug socket are not used. Especially, since the electric power is supplied only when the electrical devices are used in a home network system, it is possible to efficiently use electricity, significantly reduce unnecessary power consumption, and thus the cost is reduced. Moreover, in the case of a built-in plug socket, it is possible to change the time or method for cutting off electric power by setting a desired mode according to the kind of the electrical device, and thus user convenience is significantly improved.

### CROSS-REFERENCE TO RELATED APPLICATION

This application claims the priority of Korean Patent Application No. 10-2008-0019163, filed on Feb.29, 2008 in the Korean Intellectual Property Office, the disclosure of which is incorporated herein in its entirety by reference. Further, this application is the National Phase application of International Application No. PCT/KR2009/000938, filed Feb. 27, 2009, which designates the United States and was published in Korean. This application, in its entirety, is incorporated herein by reference.

### BACKGROUND OF THE INVENTION

1. Field of the Invention

The present invention relates to a plug socket and, more particularly, to a plug socket which automatically cuts off electric power supplied to a connected electrical device in response to a load current of the connected electrical device and changes a power control method for each operation mode.

2. Discussion of Related Art

In general, since electrical appliances used at home, such as TV sets, computers, microwave ovens, audio systems, etc., are used frequently, their plugs often remain plugged into a socket even when the electrical appliances are not in use for a long time.

These electrical appliances consume a certain amount of standby power even when not in use, and thus electric power is unnecessarily consumed. In order to prevent standby power consumption, the plug should be removed from the socket so that electric power is not supplied to the electrical appliances connected to the socket. However, it can be troublesome to insert and remove the plug into and from the socket each time the appliance is used.

Therefore, a plug socket with a switch for supplying or cutting off electric power to the electrical appliances connected to the plug socket is widely used.

However, it is still inconvenient to use the above plug socket since a user must operate the switch whenever he or she uses any of the corresponding electrical appliances connected to the plug socket. Moreover, when at least one electrical appliance is connected to the plug socket, the plug socket is generally hidden, and thus it is very inconvenient to operate the switch.

In order to solve the above problems, an automatic power-saving multi-plug socket has been developed. However, it is also problematic in that the use of products to be used or applied is limited and it is difficult to install the plug socket on a wall surface and to conveniently save electric power in accordance with a variety of electrical appliances.

Moreover, since it is expected that the power waste due to communication standby power between electrical appliances in a home network system will occupy more than 20% of the home's power consumption, a plan for solving this problem is urgently required.

### SUMMARY OF THE INVENTION

The present invention is directed to a plug socket which detects a load current of electric power supplied to an electrical device to determine an operation state of the electrical device, so that electric power is supplied to the electrical device or cut off. With a single plug socket of the present invention, it is possible to freely select a method for supplying or cutting off electric power to the electrical device by setting a desired mode regardless of a kind or combination of electrical devices. Thus, it is possible to prevent the waste of standby power which occupies more than 10% of a home's power consumption, improve user convenience by preventing electrical accidents and increasing the durability of the electrical devices, and save energy in a home network system.

According to an aspect of the present invention, there is provided a plug socket including a power-saving circuit supplying or cutting off electric power to a connected electrical device according to a load current; a mode setting unit setting any one of an automatic mode, a manual mode, and an optional automatic mode such that the power-saving circuit is operated in the set mode; a signal input unit connected to a jack connection unit and configured to input an operation signal to supply or cut off electric power to the power-saving circuit; and a changeover switch unit including a button or a lever to forcibly supply or cut off electric power. Here, the power-saving circuit includes a switch unit switching the input electric power so that the input electric power is supplied or cut off to the electrical device and cutting off the power supply when the signal input unit is disconnected from the jack connection unit; a load current detection unit detecting a load current according to an operation state of the electrical device and inputting a load signal; and a control unit controlling the operation of the switch unit in response to at least one of the mode set by the mode setting unit, the load signal, and the operation signal of the signal input unit.

According to another aspect of the present invention, there is provided a plug socket including an adaptor type socket main body in which a power-saving circuit is mounted to cut off electric power supplied to a connected electrical device; a first connection unit including a first connector connected to one side of the socket main body and a second connector having a shape different from that of the first connector and supplying external power to the socket main body; a connection plug detachably connected to the socket main body; and a signal input unit inputting an operation signal to the socket main body to supply or cut off electric power to the electrical device.

According to still another aspect of the present invention, there is provided a plug socket including: a built-in type socket main body in which a power-saving circuit is mounted to cut off electric power supplied to a connected electrical device; a first power connection portion provided on a rear surface of the socket main body and connecting external power to the power-saving circuit such that electric power is supplied to the power-saving circuit; a second power connection portion connecting the power-saving circuit to external power; and a power-line disconnecting and fixing portion fixing a power line inserted into the first power connection portion and the second power connection portion in a first state and opening the first power connection portion and the second power connection portion such that the power line inserted and fixed to the first power connection portion and the second power connection portion is separated in a second state

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view showing a plug socket in accordance with a first embodiment of the present invention;

FIGS. 2A and 2B are perspective views showing a socket main body of FIG. 1;

FIGS. 3A and 3B are perspective views showing a plug socket in accordance with a second embodiment of the present invention;

FIG. 4 is an exploded perspective view showing the plug socket of FIG. 3;

FIG. 5A is a front view of the plug socket of FIG. 3;

FIG. 5B is a side view of the plug socket of FIG. 3;

FIG. 5C is a rear view of the plug socket of FIG. 3;

FIG. 6 is a diagram showing a mode setting unit of the plug socket of FIG. 3;

FIG. 7 is a perspective view showing a first signal input unit connected to the plug socket of FIG. 3;

FIG. 8 is a perspective view showing a second signal input unit connected to the plug socket of FIG. 3;

FIG. 9 is a block diagram showing a configuration of the plug socket of FIGS. 1 and 3;

FIG. 10 is a block diagram showing a configuration of the first signal input unit of FIG. 7;

FIG. 11 is a block diagram showing a configuration of the second signal input unit of FIG. 8;

FIGS. 12A and 12B are diagrams showing examples of use of the plug socket of FIGS. 1 and 3;

FIG. 13 is a flowchart showing a mode setting method of the plug socket of FIGS. 1 and 3;

FIG. 14 is a flowchart showing an operation in an automatic mode of the plug socket of FIGS. 1 and 3;

FIG. 15 is a flowchart showing an operation in an optional automatic mode of the plug socket of FIGS. 1 and 3;

FIG. 16 is a flowchart showing an operation in a manual/timer mode of the plug socket of FIGS. 1 and 3;

FIG. 17 is a flowchart showing an operation of the second signal input unit connected to the plug socket of FIGS. 1 and 3;

FIG. 18 is a perspective view showing a configuration of a changeover switch unit provided in the plug socket of FIGS. 1 and 3; and

FIGS. 19A and 19B are perspective views showing a detailed configuration of a switch unit provided in the plug socket of FIGS. 1 and 3.

### DETAILED DESCRIPTION OF EXEMPLARY EMBODIMENTS

Reference will now be made in detail to the present embodiments of the present invention, examples of which are illustrated in the accompanying drawings, wherein like reference numerals refer to like elements throughout. The embodiments are described below in order to explain the present invention with reference to the figures.

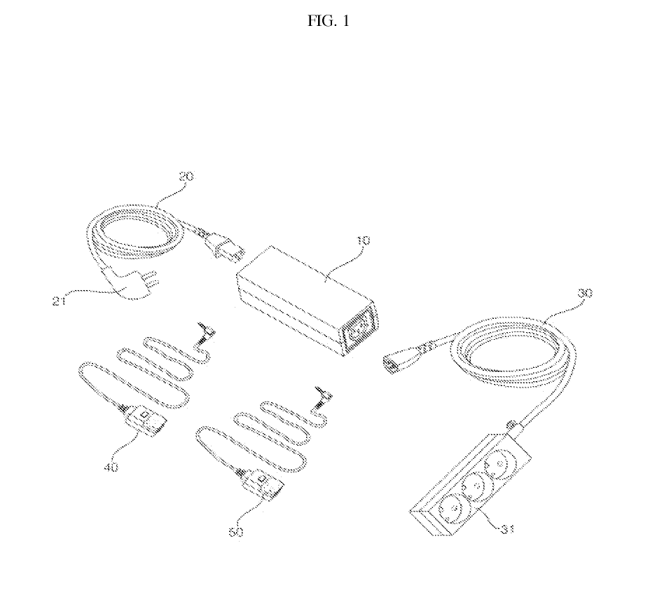

FIG. 1 is a perspective view showing a plug socket in accordance with a first embodiment of the present invention.

The plug socket in accordance with the first embodiment of the present invention is an adaptor type plug socket which is connected to any other plug socket or a connection cable to receive electric power or connected to an electrical device to supply or cut off electric power to the connected electrical device.

The plug socket includes a socket main body 10 supplying or cutting off electric power to the electrical device or any other plug socket connected to the plug socket, a first signal input unit 40 and a second signal input unit 50 inputting a predetermined signal relating to the power supply or power cut-off to the socket main body 10. In this case, each of the first and second signal input units 40 and 50 includes a connection plug in the form of an earphone jack and is connected to the socket main body 10.

The plug socket further includes a connection cable 20 connecting the plug socket to electric power such that the electric power is supplied to the socket main body 10, and a socket cable 30 supplying electric power output from the socket main body 10 to the electrical device. Here, a plug 21 of the connection cable 20 and a socket connection unit 31 of the socket cable 30 may have different shapes and forms, which are not limited to those shown in FIG. 1.

Since the plugs and the plug sockets used in different countries have different shapes, the socket main body 10 is used in common, and the connection cable 20 and the socket cable 30 connected to the socket main body 10 may be modified according to the country in which they are used. However, each of connectors 22 and 32 of the connection cable 20 and the socket cable 30 has a form suitable for the socket main body 10 and, when a connector of an electrical device has a form suitable for the socket main body 10, the connector of the electrical device can be directly connected to the socket main body 10 without the socket cable 30.

Accordingly, the socket main body may be used in common, removing a necessity to manufacture the socket main bodies separately for respective countries, and only the connection cable 20 and the socket cable 30 may be modified. Thus, it is possible to reduce waste due to design modification for each country and use the product in common.

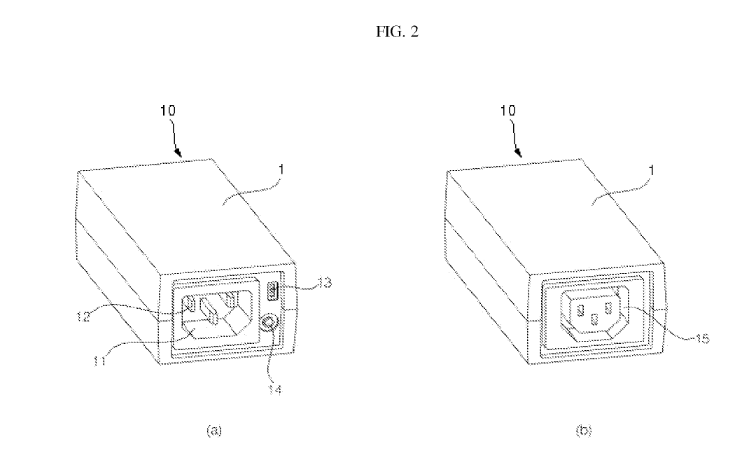

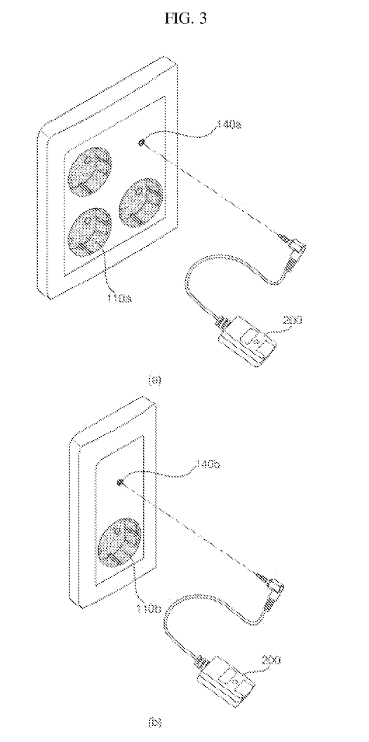

FIG. 2A is a left side perspective view showing the socket main body of FIG. 1, and FIG. 2B is a right side perspective view thereof.

As shown in FIGS. 2A and 2B, the socket main body 10 includes a power output unit 15 supplying input power to an electrical device or any other plug socket, a power input unit 12 receiving electric power, and a socket housing 1 in which a power-saving circuit for supplying or cutting off electric power according to an operation state of the electrical device or any other plug socket when the electric power input from the power input unit 12 is output through the power output unit 15 is mounted and protected. The power output unit 15 is connected to the socket cable 30, and the power input unit 12 is connected to the connection cable 20. In this case, the shapes and forms of the power output unit 15 and the power input unit 12 comply with IEC 320 C13 or IEC 320 C14 standard, but may be modified, if necessary. Moreover, the socket main body 10 includes a mode setting unit 13 and a jack connection unit 14 provided on one of upper, lower, left, and right sides of a first insertion unit 11.

The mode setting unit 13 sets a plurality of modes such that a standby time for the power supply or cut-off, a set value, a timer, or a manual cut-off is changed according to a selected mode when power is automatically cut off or supplied by the power-saving circuit.

The jack connection unit 14 is provided in the socket main body 10 such that the first signal input unit 40 or the second signal input unit 50 is detachably connected. The jack connection unit 14 receives a signal from the first signal input unit 40 or the second signal input unit 50 and applies the received signal to the power-saving circuit.

Moreover, the jack connection unit 14 determines whether the first signal input unit 40 or the second signal input unit 50 is connected thereto and, when the first signal input unit 40 or the second signal input unit 50 is disconnected therefrom, applies a detection signal to the power-saving circuit such that the socket main body 10 is switched to a normal power-off mode.

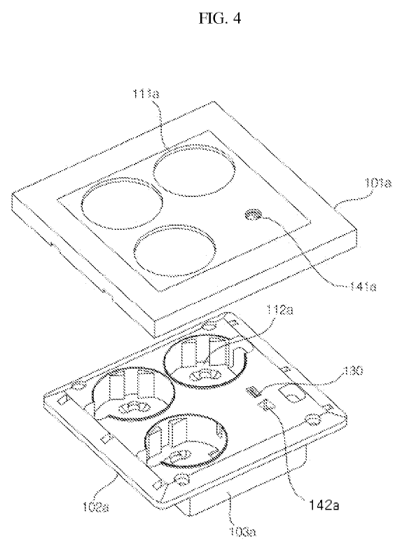

FIGS. 3A and 3B are perspective views showing a plug socket in accordance with a second embodiment of the present invention.

As shown in FIGS. 3A and 3B, the plug socket in accordance with the second embodiment of the present invention is a built-in type plug socket 100a, 100b.

The plug socket 100a, 100b includes at least one power-plug insertion hole 110a, 110b provided on the front surface such that at least one electrical device or any other plug socket is connected thereto. A power-saving circuit is mounted on the rear surface of the power-plug insertion hole 110a, 110b to supply or cut off electric power to the electrical device or any other plug socket connected to the power-plug insertion hole 110a, 110b. The power-plug insertion hole 110a, 110b of the plug socket 100a, 110b is connected to the power-saving circuit and, when a plurality of power-plug insertion holes are provided, each of the plurality of power-plug insertion holes is connected to the same power-saving circuit.

The power-saving circuit is the same as the power-saving circuit mounted on the socket main body 10 described in the first embodiment. However, since the positions and shapes of the power output unit 15 and the power input unit 12 of the socket main body 10 are different from those of the power-plug insertion hole 110a, 110b, the wiring structures with the power-saving circuit may be slightly different. However, the basic circuit configuration and function are the same.

Here, FIG. 3A shows an example in which three power-plug insertion holes 110a are provided, and FIG. 3B shows an example in which a single power-plug insertion hole 110b is provided.

Moreover, the power socket 100a, 100b includes a jack connection unit 140a, 140b in which a signal input unit 200 is inserted and mounted. As shown in FIGS. 3A and 3B, the jack connection unit 140a, 140b may be provided on one of upper, lower, left, and right sides of the power-plug insertion hole 110a, 110b.

When the signal input unit 200 is connected to the jack connection unit 140a, 140b, the jack connection unit 140a, 140b receives a predetermined signal associated with the power supply or power cut-off from the signal input unit 200. When the signal input unit 200 is connected or disconnected, the jack connection unit 140a, 140b detects the connection state and applies a detection state signal to the power-saving circuit. When the signal input unit 200 is disconnected from the jack connection unit 140a, 140b, the power-saving circuit of the power socket 100a, 100b is switched to a normal power-off mode.

The first signal input unit 40 and the second signal input unit 50 described in the first embodiment may be used as the signal input unit 200. That is, the first signal input unit 40 or the second signal input unit 50 may be connected to the jack connection unit 140a, 140b of the plug socket 100a, 100b.

The power socket 100a, 100b may further include a state output unit (not shown) which displays the operation state of the power-saving circuit or is turned on and off according to the cut-off state of electric power supplied to the connected electrical device or any other power socket.

When the plurality of power-plug insertion holes 110a are provided as shown in FIG. 3A, a normal power-on plug insertion hole, which is not connected to the power-saving circuit, may be further provided, if necessary. In this case, it is preferable that the normal power-on plug insertion hole have a color, pattern, or shape different from the plug insertion hole connected to the power-saving circuit.

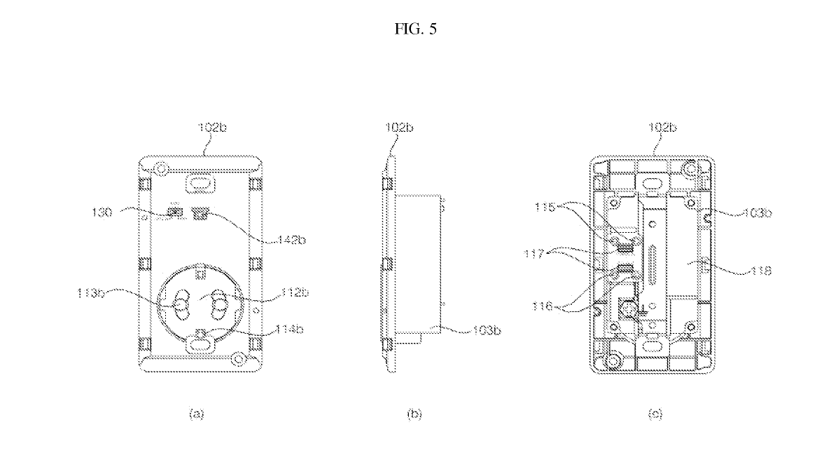

FIG. 4 is an exploded perspective view showing the plug socket of FIG. 3.

The plug socket 100a includes a front surface portion 101a, a socket assembly 102a in which the front surface portion 101a is inserted and mounted, and a main body portion 103a in which the power-saving circuit is mounted. The socket assembly 102a and the main body portion 103a are detachably connected to each other.

The front surface portion 101a includes power plug holes 111a through which the plug is inserted and mounted to the power-plug insertion hole 110a. The power plug holes 111a correspond in number to the power-plug insertion holes. Moreover, the front surface portion 101a includes an insertion hole 141a provided on one side of the power plug hole 111a such that the signal input unit 200 is inserted and mounted to the jack connection unit 140a.

The insertion hole 141 a has a circular shape such that the connection plug in the form of an earphone jack is inserted. However, the shape of insertion hole 141a may depend on the shape of the connection jack of the signal input unit 200.

The socket assembly 102a includes at least one power plug mounting portion 112a having such a structure that the plug passing through the power plug hole 111a can be inserted and mounted, and a jack mounting portion 142a in which the connection plug of the signal input unit 200 passing through the insertion hole 141a is inserted and mounted.

Moreover, the socket assembly 102a includes a mode setting unit 130 provided on one of upper, lower, left, and right sides of the jack mounting portion 142a. In this case, the mode setting unit 130 has the same configuration and function as the mode setting unit 13 described in the first embodiment.

The mode setting unit 130 is not exposed to the outside when the front surface portion 101a is mounted on the socket assembly 102a but is exposed when the front surface portion 101a is detached and the socket assembly 102a is exposed such that a user may operate the mode setting unit 130.

The main body portion 103a is located on the rear surface of the socket assembly 102a and includes a circuit board on which the power-saving circuit is mounted. The main body portion 103a is inserted into or connected to the socket assembly 102a.

The insertion hole 141a, the jack mounting portion 142a, and the jack connection unit 14, 140a are aligned at the same position so that the signal input unit 200 can be connected, and the jack connection unit 14, 140a is connected to the circuit board inside the main body portion 103a.

The socket assembly may further include a changeover switch unit (not shown) provided on one of upper, lower, left, and right sides of the plug mounting portion 112a to be manually operated such that the plug socket 100a is switched to a normal power-on or power-saving mode. The changeover switch unit is connected to the main body portion 103a to supply electric power to a power output terminal according to the operation state.

Here, the changeover switch unit, which switches the plug socket to a normal power-off or power-saving mode, may further include a push button or a lever manually operated to forcibly switch the power supply state according to whether the signal input unit 200 is mounted on or disconnected from the jack connection unit 14, 140a.

When the signal input unit 200 is connected and the changeover switch unit is set to a power saving mode, the plug socket 100a supplies the input power to the electrical device or any other plug socket connected to the power-plug insertion hole 110a through the power-saving circuit. When the signal input unit 200 is disconnected, an operation signal applied to a switch unit in the power-saving circuit is cut off such that the plug socket is switched to a normal power-off mode. Thus, when the signal input unit 200 is disconnected, the power supply to the outside or the connected electrical device is cut off.

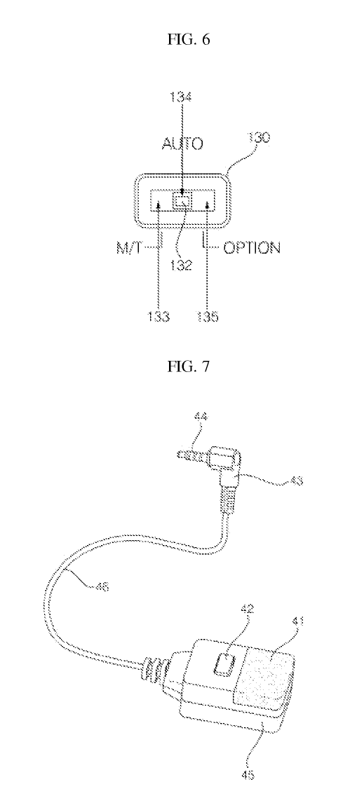

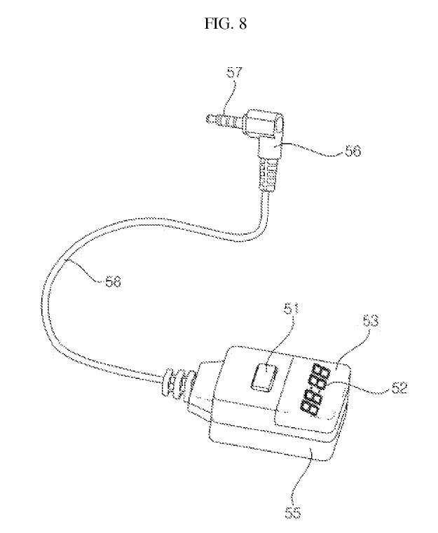

FIGS. 5A, 5B, and 5C are a front view, a side view, and a rear view of the plug socket of FIG. 3. Specifically, FIG. 5A is a front view of the socket assembly, FIG. 5B is a side view showing the socket assembly connected to the main body portion, and FIG. 5C is a rear view of the socket assembly and the main body portion. Referring to FIG. 5A, the plug socket 100b includes the power plug mounting portion 112b, the jack mounting portion 142b, and the mode setting unit 130, which are provided on the front surface of the socket assembly, as shown in FIG. 4. The power plug mounting portion 112b includes an electrode insertion portion 113b in which an electrode of the plug is inserted and a ground portion 114b providing a ground to the plug.

Moreover, the socket assembly 102b includes at least one screw hole through which a screw is inserted to fix the socket assembly 102 to a wall and at least one fixing portion into which the front surface portion is inserted and fixed.

Referring to FIG. 5B, the main body portion 103b is connected to the rear surface of the socket assembly 102b. In this case, the power plug mounting portion 112b, the jack mounting portion 142b, and the mode setting unit 130 of the socket assembly 102b are connected to the circuit board inside the main body portion 103b.

Referring to FIG. 5C, the plug socket 100b includes a rear surface housing 118 connected to the rear surface of the socket assembly 102b, and the rear surface housing 118 has a rectangular cover structure to protect the circuit board inside the main body portion 103b and the power-saving circuit mounted on the circuit board such that the power-saving circuit is not exposed to the outside.

The rear surface housing 118 includes a first power connection portion 115 for applying external power to the power-saving circuit, a second power connection portion 116 supplying electric power of the power-saving circuit to the outside, and a power-line disconnecting and fixing portion 117 capable of fixing or disconnecting an inserted power line.

The power-line disconnecting and fixing portion 117 closes the first and second power connection portions 115 and 116 in a normal state to fix the power line inserted into the power connection portions 115 and 116 and prevents foreign materials from entering the power connection portions 115 and 116 when the power line is not connected.

Moreover, the power-line disconnecting and fixing portion 117 opens the power connection portions 115 and 116, when two power-line disconnecting and fixing portions 117 are operated to face each other, to allow the user to insert the power line to the power connection portions 115 and 116 or remove the inserted power line therefrom.

FIG. 6 is a diagram showing the mode setting unit of the plug socket of FIGS. 1 and 3.

As shown in FIG. 6, the mode setting unit 13, 130 in the plug socket includes a predetermined input means capable of setting a mode in multi-steps such that electric power to an electrical device or any other plug socket connected to the plug socket is supplied or cut off.

Here, the mode setting unit 13, 130 may be a slide switch capable of setting the mode in three steps; however, a rotary switch, a plurality of buttons, or a DIP switch capable of setting the mode in at least three steps may be used.

The mode setting unit 13, 130 sets the mode according to the position of a switch bar 132 and applies mode information to the power-saving circuit. Here, the mode setting unit 13, 130 may set three modes such as an optional automatic mode, an automatic mode, and a manual/timer mode.

When the switch bar 132 is located at a first position 135, the mode setting unit 13, 130 applies a signal for setting the optional automatic mode to the power-saving circuit, and thus the plug socket is set to the optional automatic mode. When the switch bar 132 is located at a second position 134, the mode setting unit 13, 130 applies a signal for setting the automatic mode to the power-saving circuit, and thus the plug socket is set to the automatic mode. When the switch bar 132 is located at a third position 133, the mode setting unit 13, 130 applies a signal for setting the manual/timer mode to the power-saving circuit.

When any one of the modes is set by the mode setting unit 13, 130, a standby time until the power is cut off, a type of a signal input from the signal input unit 200, a method of inputting the signal, and a type of an input control command are set differently according to the set mode of the plug socket.

As mentioned above, the plug socket includes the signal input unit 200 detachably connected to the socket main body 10, 100a, 100b by a lead wire to input a predetermined control signal relating to the power supply or power cut-off to an electrical device or any other plug socket connected to the plug socket.

The signal input unit 200 includes the first signal input unit 40 receiving a radio signal and a control signal by a manual operation and inputting an operation signal, and the second signal input unit 50 inputting an operation signal by a manual operation or a control signal by a timer.

FIG. 7 is a perspective view showing the first signal input unit connected to the plug socket of FIGS. 1 and 3.

Referring to FIG. 7, the first signal input unit 40 includes a connection plug 43 inserted into the jack connection unit 14, 140, 420, a main body 45 including a signal receiving unit 41 and an input unit 42, and a lead wire 46 connecting the main body 45 to the connection plug 43.

The connection plug 43 includes a connection portion 44 in the form of an earplug detachably connected to the jack connection unit 14, 140, 420. The connection portion 44 consists of a plurality of connection terminals 44 such that, when the connection plug 43 is inserted into the jack connection unit 14, 140, 420, each connection terminal 44 is connected to a signal terminal provided in the jack connection unit 14, 140, 420 to deliver a signal.

The input unit 42 includes at least a button for applying an operation signal when it is pressed.

The signal receiving unit 41 includes a radio signal module for receiving an infrared signal or any other radio signal and receives a signal output from a remote controller of the electrical device, such as a television (TV) set, a radio, an air conditioner, a video player, etc., or any other radio signal.

When a radio signal is received via the signal receiving unit 41, the first signal input unit 40 applies the received radio signal to the plug socket through the connection plug 43. When the button of the input unit 42 is pressed, the first signal input unit 40 applies a predetermined operation signal to the power-saving circuit of the plug socket through the connection plug 43.

FIG. 8 is a perspective view showing the second signal input unit 50 connected to the plug socket of FIGS. 1 and 3.

Referring to FIG. 8, the second signal input unit 50 includes a connection plug 56 inserted into the jack connection unit 14, 140, 420, a time input unit 51, a time output unit 52, a first housing 53 formed of a transparent or translucent material covering the time output unit 52, a main body 55 that is a housing for accommodating the time input unit 51, the time output unit 52, and a control circuit provided therein, and a lead wire 58 connecting the main body 55 to the connection plug 56.

The connection plug 56 has the same shape as the first signal input unit 40, and thus includes a plurality of connection terminals 57. The connection plug 56 is inserted into the jack connection unit 14, 140, 420 to apply a predetermined control signal to the power-saving circuit.

The time input unit 51 includes at least one push button to input a set time of a timer corresponding to the number of times the button is pressed. In this case, the time input unit 51 inputs different signals when the button is pressed one time and when the button is pressed for more than a predetermined time (long key input).

The time output unit 52 displays a timer time input by the time input unit 51. The time output unit 52 displays the time increased or decreased by the operation of the time input unit 51. The time output unit 52 may include, but is not limited to, an LCD capable of outputting, for example, a four digit number.

In this case, the time output unit 52 displays the hour in the first two digits and the minutes in the last two digits. For example, 03:30 represents three hours and thirty minutes.

When the timer time set by the time input unit 51 has elapsed, the second signal input unit 50 delivers an operation signal generated from the control circuit to the power-saving circuit of the plug socket through the connection plug 56.

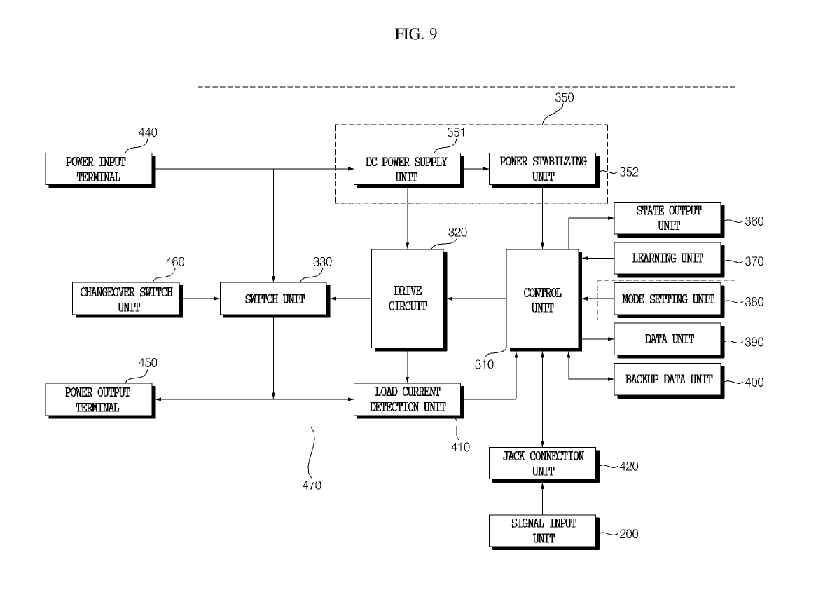

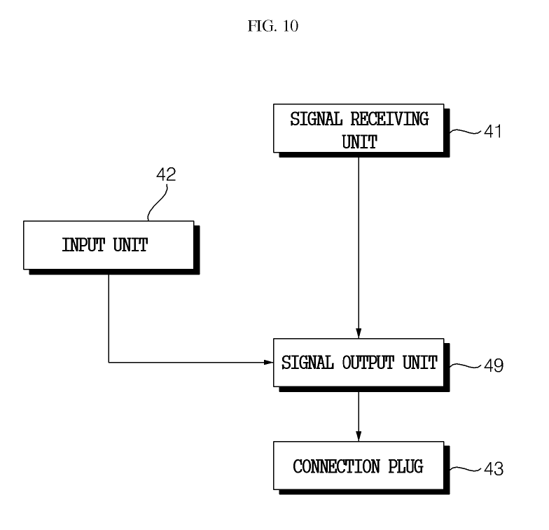

FIG. 9 is a block diagram showing a configuration of the plug socket of FIGS. 1 and 3.

As shown in FIG. 9, the plug socket includes a power input terminal 440, a power output terminal 450, a signal input unit 200, a mode setting unit 380, a jack connection unit 420, and a power-saving circuit 470. The plug socket further includes a changeover switch 460 capable of being manually operated. The power input terminal 440 is connected to the power input unit 12 of the first embodiment and the power connection portions 115 of the second embodiment to supply electric power to the plug socket. The power input terminal 440 is connected to the power output unit 15 of the first embodiment and the power-plug insertion hole 110a, 110b and the power connection portions 116 of the second embodiment such that the electric power of the power input terminal 440 is supplied to the connected electrical device or any other plug socket through the power-saving circuit 470.

When any one of the optional automatic mode, the automatic mode, and the manual/timer mode is selected, the mode setting unit 380 transmits information regarding the selected mode to the power-saving circuit 470.

The signal input unit 200 is detachably connected to the jack connection unit 420 and inputs a predetermined control signal relating to the power supply or power cut-off. The signal input unit 200 is connected to the jack connection unit 420 by a lead wire and includes the first signal input unit 40 having the radio signal module for receiving an infrared or any other radio signal and a button applying a signal when it is pressed, and the second signal input unit 50 capable of setting a timer.

In this case, when the signal input unit 200 is connected to the jack connection unit 420, the plug socket operates in a power-saving mode to cut off standby power for the electrical device or any other plug socket by the power-saving circuit.

On the other hand, when the signal input unit 200 is disconnected from the jack connection unit 420, the plug socket is switched to a normal power-off mode, thus safely cutting off the power supply to the outside or the connected electrical device.

When the signal input unit 200 is disconnected from the jack connection unit 420, the connection between a switch unit 330 and a drive circuit 320 or a control unit 310 is cut off such that the switch unit 330 is turned off. Thus, the plug socket is switched to an automatic power-off mode and the power supply to the connected electrical device or any other plug socket is cut off. Moreover, when the signal input unit 200 is disconnected from the jack connection unit 420, the power supplied to the control unit 310 is cut off, and thus the control unit 310 cannot perform the control operation according to the power supply or power cut-off.

When the power supply is cut off as the signal input unit 200 is disconnected from the jack connection unit 420, the changeover switch 460 may be operated by the user to enable the power supply such that the plug socket is switched to a normal power-on mode in the event of failure of the power-saving circuit.

In this case, when the changeover switch 460 is operated by the user, the switch unit 330 included in the power-saving circuit is forcibly turned on without a control signal of the control unit 310 such that the power is supplied to the connected electrical device or any other plug socket. At this time, since the power is supplied regardless of the control of the control unit 310 when the power supply is made by the operation of the changeover switch 460, the plug socket operates in the normal power-on mode.

Since the power supply is cut off when the signal input unit 200 is disconnected from the jack connection unit 420, the changeover switch 460 can be used to switch the plug socket into the normal power-on mode in the event that the use of the plug socket is impossible due to a failure of the power-saving circuit or when there is no signal input unit 200.

The power-saving circuit 470 detects a load current with respect to the electric power flowing from the power input terminal 440 to the power output terminal 450 to determine an operation state of the connected electrical device or any other plug socket, thus supplying or cutting off the electric power to the connected electrical device or any other plug socket.

The power-saving circuit 470 includes the switch unit 330, a power supply unit 350, the drive circuit 320, a load current detection unit 410, a state output unit 360, a learning unit 370, a data unit 390, and the control unit 310 controlling the entire operation of the power-saving circuit 470 and the plug socket.

The power-saving circuit 470 further includes a backup data unit 400.

The switch unit 330 is connected between the power input terminal 440 and the power output terminal 450 to allow the electric power to the electrical device or any other plug socket to be supplied or cut off. In this case, the switch unit 330 may be a relay turned on/off by the electric power supplied by the drive circuit 320. Alternatively, the switch unit 330 may be any switchable element such as a transistor.

The drive circuit 320 applies electric power to the switch unit 330 in response to the control command from the control unit 310 to control the switching operation of the switch unit 330. The drive circuit 320 includes a plurality of diodes, transistors, resistors, and capacitors.

The power supply unit 350 converts the electric power input from the power input terminal 440 and supplies a driving power to the control unit 310. The power supply unit 350 converts an AC voltage applied from the power input terminal 440 into a DC voltage and stabilizes the converted DC voltage. At this time, the power supply unit 350 applies the DC voltage to the control unit 310 or the drive circuit 320 such that the power-saving circuit is operated.

The data unit 390 stores a load detection value, which is a reference value to determine that the power supply is automatically cut off as the control unit 310 controls the switch unit 330 to be switched according to a load signal input from the load current detection unit 410, and stores a delay time until the power supply is cut off, data for recognizing the operation signal input from the signal input unit 200, and data learned by the learning unit 370. The backup data unit 400 stores the data stored in the data unit 390 such as the load detection value, the delay time data, the operation signal recognizing data, and the learned data.

When the mode setting unit 380 sets the optional automatic mode, the learning unit 370 sets a new reference value of the power cut-off according to the load current detected by the load current detection unit 410. The newly set reference value is stored as the learned data in the data unit 390 and used as a reference value of the control unit 310 when the optional automatic mode is maintained. Moreover, the learning unit 370 registers an infrared or any other radio signal input from the first signal input unit 40 and stores it in the data unit 390.

The state output unit 360 is turned on and off according to the power supply state by the power-saving circuit, i.e., according to whether the electric power is normally supplied or cut off and outputs state information. In this case, a lamp turned on and off may be used as the state output unit 360.

The load current detection unit 410 detects a load current from the electric power supplied by the switch unit 330 and inputs a load signal to the control unit 310.

When the electric power is supplied to the electrical device or any other plug socket as the switch unit 330 is turned on, the load current detection unit 410 detects a load current from the supplied electric power, removes power noise or overvoltage contained in the electric power, converts it into a DC voltage, and outputs a load signal to the control unit 310 to determine the operation state of the electrical device or any other plug socket.

The control unit 310 controls the drive circuit 320 to allow the switch unit 330 to operate in response to the operation signal, the infrared signal or any other radio signal input from the signal input unit 200 or the load signal input from the load current detection unit 410.

When the operation signal is input from the signal input unit 200, the control unit 310 generates a control command and applies it to the drive circuit 320 such that the switch unit 330 is turned on and thus the electric power is supplied to the electrical device or any other plug socket. At this time, the control unit 310 receives the operation signal from the signal input unit 200 and determines whether to supply or cut off the electric power in response to the mode set by the mode setting unit 380.

Moreover, the control unit 310 detects the mounting state of the signal input unit 200 from the jack connection unit 420 and supplies or cuts off the electric power according to the mounting state. When it is detected that the signal input unit 200 is connected to the jack connection unit 420, the control unit 310 switches the plug socket to the power supply state immediately.

When the signal input unit 200 is connected to the jack connection unit 420, the control unit 310 determines the operation state of the electrical device or a plurality of electrical devices connected to another plug socket based on the load signal input from the load current detection unit 410 and applies a control command to the drive circuit 320 such that the electric power is automatically supplied or cut off.

The control unit 310 compares the load signal input from the load current detection unit 410 with a predetermined load detection value and, if the load signal is less than the load detection value, determines a standby power state as the electric power of the electrical device or the plurality of electrical devices connected to another plug socket is cut off. Thus, the control unit 310 controls the electric power to be automatically cut off after a predetermined time elapses.

When the automatic mode is set by the mode setting unit 380, the control unit 310 receives a load signal corresponding to the load current measured by the load current detection unit 410 and compares the received load signal with a predetermined reference value, thus determining the operation state of the electrical device or any other plug socket connected to the power output terminal 450. If the load signal is less than the reference value, the control unit 310 determines that the operation of the electrical device or any other plug socket is stopped, i.e., determines that standby power is consumed, and controls the switch unit 330 to be turned off such that the electric power supplied to the electrical device or any other plug socket is automatically cut off.

When the operation signal is input from the signal input unit 200 during the automatic mode, the control unit 310 controls the switch unit 330 to release the power cut-off such that the electric power is supplied to the electrical device or any other plug socket. In the case where the signal input unit 200 is the first signal input unit 40, when an infrared signal or any other radio signal is input, a signal is applied from the first signal input unit 40 to the control unit 310 and, when the button of the input unit is operated, an operation signal is applied to the control unit 310. Moreover, in the case where the signal input unit 200 is the second signal input unit 50, when the time input unit 51 is operated, an operation signal is applied to the control unit 310.

In this case, the control unit 310 controls the learning unit 370 at the initial stage of the automatic mode such that the infrared signal or any other radio signal of the first signal input unit 40 is registered. The learning unit 370 registers the input infrared signal or any other radio signal in response to the signal input from the input unit 42 of the first signal input unit 40 based on the control command of the control unit 310 and stores the infrared signal or any other radio signal in the data unit 390.

For example, when the button of the input unit 42 of the first signal input unit 40 is pressed for more than a predetermined time, the control unit 310 controls the learning unit 370 to register the infrared signal or any other radio signal. Moreover, when the signal can be registered in the above manner, the signal receiving unit 41 of the first signal input unit 40 receives a signal output when the remote controller is operated by the user and applies the received signal to the plug socket, and the learning unit 370 registers the input infrared signal or any other radio signal.

Here, when the infrared signal or any other radio signal can be registered, the control unit 310 controls the state output unit 360 to allow the user to recognize that the registration of the infrared signal or any other radio signal is available. When the registration of the infrared signal or any other radio signal is completed by the learning unit 370, the control unit 310 controls the state output unit 360 to display the result. When a lamp is provided in the first signal input unit 40, the control unit 310 applies a predetermined signal to the first signal input unit 40 to inform that the signal registration is available or completed through the lamp provided in the first signal input unit 40.

As such, when the infrared signal or any other radio signal is registered by the learning unit 370, the control unit 310 compares an infrared signal or any other radio signal input from the first signal input unit 40 with the registered signal. When they are the same signal, the control unit 310 recognizes the input signal as an operation signal and thus controls the switch unit 330 to release the power cut-off such that the electric power is supplied to the electrical device or any other plug socket. When the input signal is different from the registered signal, the control unit 310 ignores the input signal.

When the manual/timer mode is set by the mode setting unit 380, the control unit 310 supplies or cuts off the electric power to the connected electrical device or any other plug socket according to the operation signal input from the signal input unit 200.

At this time, when the operation signal is input from the signal input unit 200 while the electric power is supplied to the electrical device or any other plug socket, the control unit 310 controls the switch unit 330 to supply or cut off the electric power regardless of the load signal of the load current detection unit 410.

Moreover, when the optional automatic mode is set, the control unit 310 controls the learning unit 370 to perform a standby power learning mode. At this time, the control unit 310 determines the operation state of the electrical device or any other plug socket based on the load signal of the load current detection unit 410 using a reference value newly set by the learning unit 370 and controls the switch unit 330.

At this time, the learning unit 370 receives a load current value measured by the load current detection unit 410 according to the control command of the control unit 310, sets a standby power value corresponding to the received value as a new reference value, and stores the set value in the data unit 390.

That is, the learning unit 370 controls the load current detection unit 410 to measure the standby power consumed by the connected electrical device or any other plug socket for a predetermined time. The learning unit 370 automatically sets the load detection value for the power cut-off and the delay time until the power is cut off in response to the magnitude of the standby power measured by the load current detection unit 410.

At this time, the control unit 310 controls the lamp of the state output unit 360 to be turned on and off, thus displaying the learning mode state.

Here, the load current detection unit 410 includes a conversion unit (not shown) connected to the switch unit 330 and the power output terminal 450 to detect a load current from the supplied power, remove overvoltage or overcurrent contained in the detected AC voltage, and convert the AC voltage into a ripple voltage, a smoothing unit (not shown) smoothing the ripple voltage and applying a DC load signal to the control unit 310, and a discharge unit (not shown). However, detailed descriptions thereof will be omitted for brevity.

Moreover, when the optional automatic mode is set, the control unit 310 controls the learning unit 370 in the same manner as the above-described automatic mode such that the infrared signal or any other radio signal is registered and, once the registration of the infrared signal or any other radio signal is completed, cuts off the power supply in response to the registered signal.

Here, when the registration of the infrared signal or any other radio signal is completed during the automatic mode, the registered signal can be used when the automatic mode is switched to the optional automatic mode without signal registration. The infrared signal or any other radio signal registered in the optional automatic mode can also be used in the automatic mode. At this time, the registered infrared or radio signal is stored in the data unit 390.

The plug socket may further include a noise removing unit (not shown).

The noise removing unit absorbs and removes noise input from the power output terminal 450. In this case, the noise removing unit may be connected between the switch unit 330 of the power-saving circuit and the power output terminal 450 and include a diode connected across the power output terminal 450.

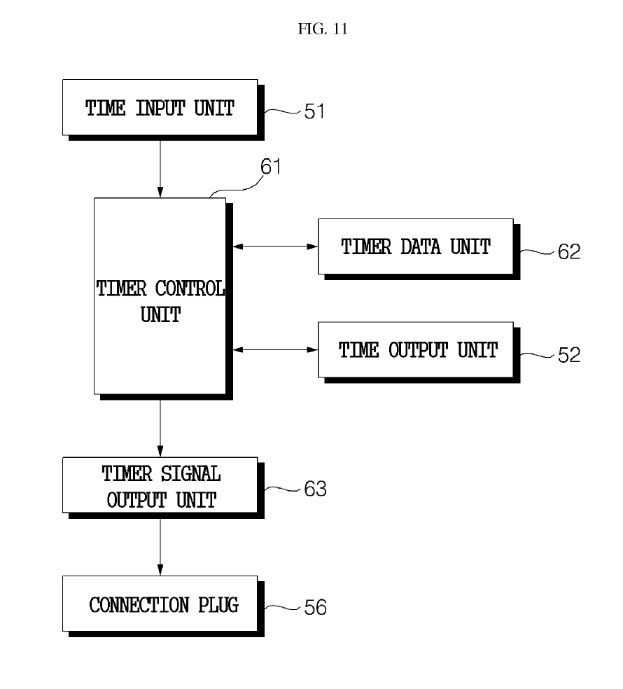

FIG. 10 is a block diagram showing a configuration of the first signal input unit of FIG. 7.

Referring to FIGS. 7 and 10, the first signal input unit 40 includes the connection plug 43, the signal receiving unit 41, and the input unit 42. The first signal input unit 40 further includes a signal output unit 49 outputting signals of the signal receiving unit 41 and the input unit 42 to the socket main body 10, 100a, 100b. The first signal input unit 40 may further include a lamp for indicating an operation state.

The first signal input unit 40 may perform a remote controller setting operation such that an infrared signal or any other radio signal of a specific remote controller is registered and stored by the control unit 310 and the learning unit 370. In this case, the registration of the infrared signal or any other radio signal may be performed when the plug socket is in the automatic mode or the optional automatic mode.

When the registration of the infrared signal or any other radio signal is completed by the first signal input unit 40, the control unit 310 recognizes the input signal as the operation signal only when the infrared signal or any other radio signal input from the first signal input unit 40 is the registered signal and ignores a signal from any other remote controller. Here, a plurality of infrared signals or other radio signals may be registered, and an infrared signal or any other radio signal for each button in one remote controller may be registered.

Here, when the button of the input unit 42 is pressed for more than a predetermined time, the first signal input unit 40 applies a corresponding signal to the control unit 310, which switches to an infrared signal or any other radio signal setting mode to receive an infrared signal or any other radio signal through the signal receiving unit 41 and control the learning unit 370 to register the received infrared signal or any other radio signal.

In the case where the plug socket is in the automatic mode or the optional automatic mode, when an infrared signal or any other radio signal is received from the signal receiving unit 41 while the connection plug 43 is mounted on the socket main body 10, 100a, 100b, the first signal input unit 40 applies the infrared signal or any other radio signal to the signal output unit 49 and delivers a signal to the jack connection unit 420 of the plug socket through the connection plug 43.

The control unit 310 which has received the infrared signal or any other radio signal from the jack connection unit 420 compares the received signal with the registered infrared or radio signal and, if the received signal is the registered signal, controls the drive circuit 320 by generating an operation signal to release the power cut-off and supply a electric power. Thus, the switch unit 330 is turned on and the electric power is supplied to the electrical device or any other plug socket.

Moreover, the first signal input unit 40 applies an operation signal for the power supply to the plug socket in response to the operation of the button of the input unit 42.

A remote controller of the connected electrical device may be used as the first signal input unit 40 without a dedicated remote controller, and a specific remote controller may be designated and used since it can be set to receive only an infrared signal or any other radio signal of a specific frequency set by learning.

Meanwhile, in the case where the plug socket is set to the manual/timer mode, when the button of the input unit 42 of the first signal input unit 40 is pressed, an operation signal is applied from the signal output unit 49 to the plug socket through the connection plug 43. Then, the control unit 310 controls the electric power to be supplied or cut off in response to the operation signal input from the manual/timer mode.

For example, in the case where the plug socket is set to the manual/timer mode, when the input unit 42 of the first signal input unit 40 is operated once, the control unit 310 receives an operation signal through the jack connection unit 420 to cut off the supplied power or supply the cut-off power. The electric power is cut off or supplied each time the operation signal of the first signal input unit 40 is input, which may be used when the electric power is manually cut off or supplied by the user.

However, when the plug socket is set to the manual/timer mode, since the first signal input unit 40 does not have the timer function, the plug socket performs only the power supply or power cut-off according to the manual operation.

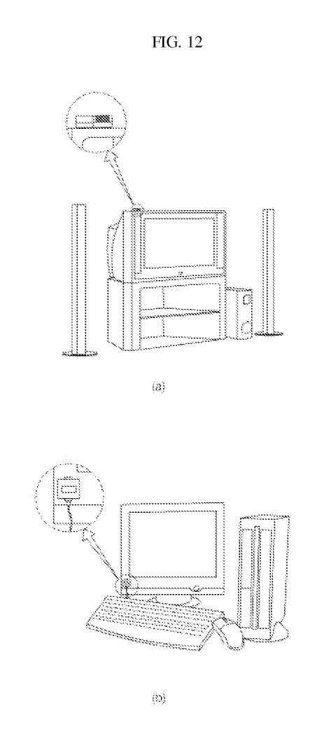

FIG. 11 is a block diagram showing a configuration of the second signal input unit of FIG. 8.

Referring to FIGS. 8 and 11, the second signal input unit 50 includes the connection plug 56, the time input unit 51, and the time output unit 52. Moreover, the second signal input unit 50 includes a timer control unit 61 controlling input and output of a signal and controlling the entire operation of the second signal input unit 50, a timer data unit 62 in which time set data is stored, and a timer signal output unit 63 transmitting a timer control signal generated by the timer control unit 61 to the socket main body 10, 100a, 100b through the connection plug 56.

In this case, the time input unit 51 increases the set time of the timer corresponding to the number of times the button is pressed and inputs the increased timer time. The set time of the timer is increased within a given maximum time and, when reaching the maximum time, it is decreased corresponding to the number of times the button is pressed or increased from zero.

Moreover, when the button of the time input unit 51 is pressed for more than a predetermined time (long key input), the time input unit 51 initializes the input set time and, at the same time, stops the operation of the second signal input unit 50. Furthermore, when the button of the time input unit 51 is continuously pressed a predetermined number of times, the set time is repeated such that the operation signal may be transmitted periodically.

In this case, the second signal input unit 50 may further include a setting switch unit (not shown) for allowing the set time to be repeated periodically.

The time input unit 51 divides the given maximum time into a plurality of time frames such that the time is increased in different increments at each time frame.

For example, the time input unit 51 inputs the set time of the timer increased in increments of 10 minutes each time the button of the time input unit 51 is pressed in a first time frame, increments of 20 minutes in a second time frame, increments of 30 minutes in a third time frame, and increments of 1 hour in a fourth time frame.

That is, if the given maximum time is about 20 hours, the set time of the timer may be increased in increments of 10 minutes each time the button of the time input unit 51 is pressed up to 40 minutes, increments of 20 minutes up to 2 hours, increments of 30 minutes up to 4 hours, and increments of 1 hour up to 20 hours, the maximum time.

When the set time of the timer is input by the time input unit 51, the timer control unit 61 counts the time and, when the time reaches the set time, outputs a control signal according to the power cut-off or power supply to the plug socket.

The second signal input unit 50 having the above-described configuration, which is mounted in the socket main body 10, 100a, 100b, applies an operation signal to the control unit 310 in response to the timer time set by the operation of the time input unit 51 such that the electric power is supplied or cut off. Moreover, when the timer time is set to be repeated, the second signal input unit 50 counts the set time of the timer periodically and applies an operation signal to the control unit 310.

When the plug socket is in the manual/timer mode, the second signal input unit 50 applies an operation signal according to the timer time set in the above manner and, when the plug socket is in the automatic mode or optional automatic mode, applies an operation signal during operation of the time input unit 51 to supply the cut-off electric power. That is, when the plug socket is in the automatic mode or optional automatic mode, the time input unit 51 of the second signal input unit 50 operates in the same manner as the input unit 42 of the first signal input unit 40.

FIGS. 12A and 12B are diagrams showing examples of use of the plug socket of FIGS. 1 and 3.

As shown in FIGS. 12A and 12B, the plug socket is connected to an electrical device or any other plug socket to supply or cut off electric power to the connected electrical device or any other plug socket.

In the case where the signal input unit 200 is connected to one side of the connected electrical device, when the power of the electrical device is turned off, the power supply is automatically cut off to prevent standby power consumption and, when the user operates the signal input unit 200 using a remote controller or directly presses the button provided on the signal input unit 200, an operation signal is input from the signal input unit 200 to allow the electric power to be supplied to the electrical device.

Accordingly, the electric power is normally supplied to the electrical device and, when the user drives the electrical device, the electrical device normally operates. Then, when a load current is detected by the load current detection unit 410 as the power is consumed, the control unit 310 continuously switches the switch unit 330 through the drive circuit 320 while not being affected by the infrared signal or any other radio signal or the operation of the button.

For example, in the case where the first signal input unit 40 is connected to any part of the front surface of the TV set, when the power of the TV set is turned off during the automatic mode of the plug socket, the power supplied to the TV set is automatically cut off by the power-saving circuit after a predetermined time elapses. Then, when a remote controller is operated by the user, the first signal input unit 40 receives an infrared signal or any other radio signal and applies an operation signal to the power-saving circuit such that the electric power is supplied to the electrical device. Next, when the remote controller is operated once again, the TV set receives a signal from the remote controller and is driven.

Here, since the power of the TV set is cut off during the first operation of the remote controller, the TV set cannot receive the remote control signal; however, since the electric power is normally supplied to the TV set during the second operation of the remote controller, the TV set can receive the remote control signal using the standby power.

Moreover, in the case where an electric mat is connected to the plug socket in the manual/timer mode and the first signal input unit is connected to the electric mat, when the button of the first signal input unit is pressed or a remote controller is operated, the power supply to the electric mat is cut off, and thus the operation of the electric mat is stopped. Then, when the button is pressed one time or the remote controller is operated, the electric power is supplied to the electric mat, and thus the operation of the electric mat is restarted.

When the second signal input unit is connected to the electric mat and the timer is set, the electric mat is operated until the set time. After the set time elapses, the power supply to the electric mat is cut off and the operation of the electric mat is stopped. At this time, when the second signal input unit is set to the repetitive mode, the electric power is supplied after the set time elapses, and thus the operation of the electric mat is restarted.

Operation of the plug socket having the above configuration in accordance with the present invention will now be described.

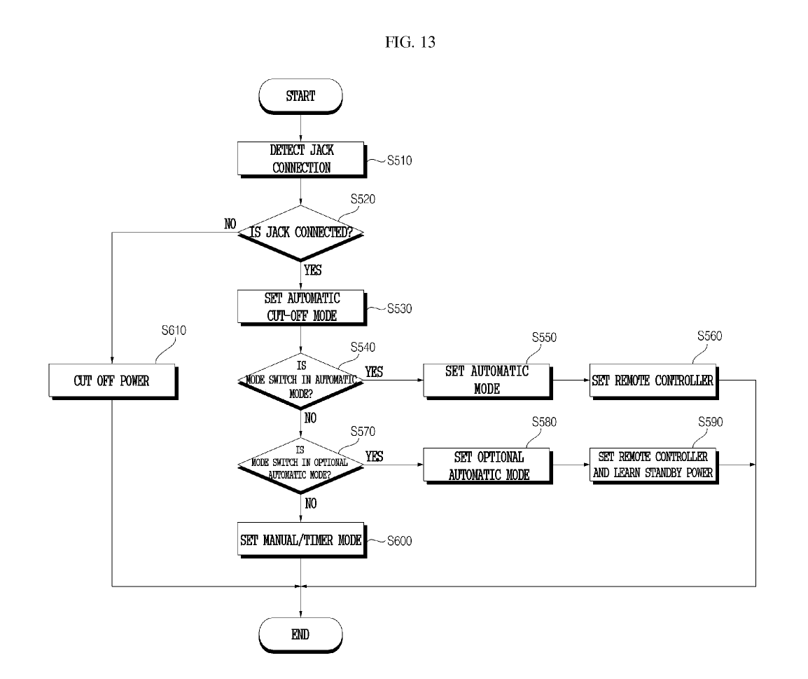

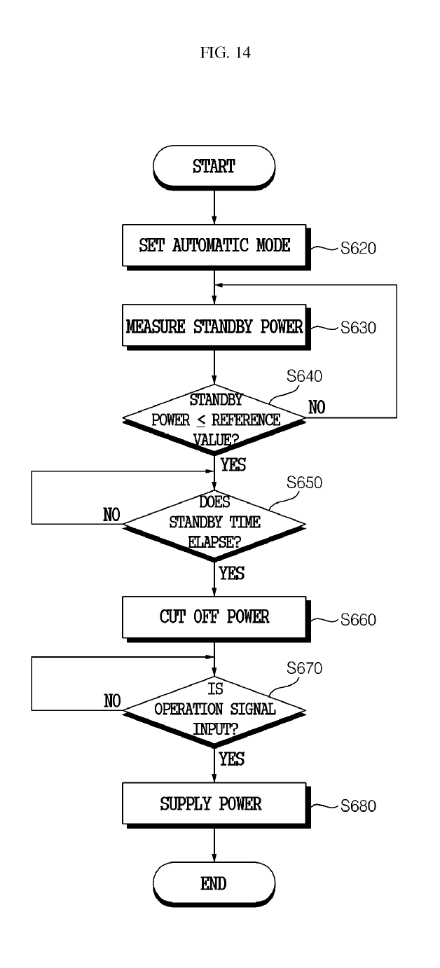

FIG. 13 is a flowchart showing a mode setting method of the plug socket of FIGS. 1 and 3.

As shown in FIG. 13, the plug socket is operated in a power-saving mode or normal power-off mode according to whether the signal input unit 200 is connected to the jack connection unit 420.

When the signal input unit 200 is not connected to the jack connection unit 420 (S520), the connection between the control unit 310 or the drive circuit 320 and the switch unit 330 is cut off, and thus the switch unit 330 is turned off and the power supply to the connected electrical device or any other plug socket is cut off. Thus, the plug socket is operated in the normal power-off mode (S610). At this time, the operation power applied to the control unit 310 is also cut off, and thus the control unit 310 is not operated.

When the signal input unit 200 is connected to the jack connection unit 420, the operation power is supplied to the control unit 310 and the connection with the switch unit 330 is restored. Thus, the drive circuit 320 controls the switch unit 330 under the control of the control unit 310, and thus the switch unit 330 can perform the switching operation.

When the signal input unit 200 is connected to the jack connection unit 420 (S520), the plug socket is operated in the power-saving mode such that the electric power input from the power input terminal 440 is supplied to the power output terminal 450 through the power-saving circuit. Thus, the electric power is supplied to the connected electrical device or any other plug socket, and then the control unit 310 determines the operation state of the electrical device or any other plug socket based on the load current and supplies or cuts off the electric power based on the determination result (S530).

When the set mode of the mode setting unit 380 is the automatic mode (S540), the control unit 310 sets the automatic mode (S550) in which the control unit 310 compares a load signal applied from the load current detection unit 410 with the reference value to control the switch unit 330 such that the electric power supplied to the electrical device or any other plug socket is controlled, and controls the electric power to be supplied to the electrical device or any other plug socket in response to the infrared signal or any other radio signal input from the signal input unit 200 or an operation signal according to the operation of the button.

At this time, the control unit 310 may control the learning unit 370 to register an infrared signal or any other radio signal of a specific remote controller among the infrared signals or other radio signals input from the signal input unit 200 (S560). When the registered infrared or radio signal is input, the control unit 310 recognizes the input signal as an operation signal and controls the switching operation of the switch unit 330. Moreover, the control unit 310 receives an operation signal according to the operation of the input unit 41 of the signal input unit 200 and controls the switch unit 330.

When the set mode of the mode setting unit 380 is the optional automatic mode, the control unit 310 sets the optional automatic mode (S580) in which the control unit 310 resets a reference value by measuring the standby power and learning a value of a specific remote controller in the same manner as the automatic mode and compares the reset reference value with the load signal to control the power supply.

In the optional automatic mode, the control unit 310 controls the learning unit 370 to register an infrared signal or any other radio signal of a specific remote controller in the same manner as the automatic mode, detects a load current through the load current detection unit 410, calculates a standby power value based on the detection value, and sets a new reference value (S590).

The registered infrared or radio signal may be used in the other modes regardless of the set modes.

Meanwhile, when the set mode of the mode setting unit 380 is the manual/timer mode, the control unit 310 sets the manual/timer mode (S600), in which the control unit 310 controls the switch unit 330 to supply or cut off the electric power to the electrical device or any other plug socket in response to an operation signal of the signal input unit 200.

Operation of the plug socket in each mode set by the mode setting unit 380 will now be described.

FIG. 14 is a flowchart showing an operation in the automatic mode of the plug socket of FIGS. 1 and 3.

Referring to FIG. 14, when the plug socket is set to the automatic mode (S620), the electric power input from the power input terminal 440 is applied to the power output terminal 450 through the power-saving circuit 470 and then supplied to the connected electrical device or any other plug socket.

At this time, the load current detection unit 410 measures a load current from the electric power flowing through the power-saving circuit 470 and applies a load signal according to the load current to the control unit 310. The control unit 310 compares the input load signal with a predetermined reference value to determine whether standby power is consumed (S640).

When the load signal is less than the predetermined reference value, the control unit 310 determines that the operation of the connected electrical device or any other plug socket is stopped and standby power is consumed and stands by for a predetermined delay time (S650). After the predetermined delay time elapses, the control unit 310 controls the switch unit 330 to be turned off to cut off the power supply to the connected electrical device (S660). At this time, the drive circuit 320 controls the operation of the switch unit 330 to be turned off in response to the control command of the control unit 310.

When the switch unit 330 is turned off in the above manner, the electric power applied from the power input terminal 440 to the power output terminal 450 is cut off, and thus the electric power is not supplied to the connected electrical device.

When an operation signal according to the operation of the button is input from the signal input unit 200 (S670), the control unit 310 controls the switch unit 330 to be turned on to supply the electric power to the connected electrical device (S680).

Moreover, when an infrared signal or any other radio signal is input from the signal input unit 200, the control unit 310 compares the input infrared or radio signal with a registered signal. When they are the same signal, the control unit 310 recognizes the input signal as an operation signal and controls the switch unit 330 to be turned on to supply the electric power to the connected electrical device. Meanwhile, when the input signal is different from the registered signal, the control unit 310 ignores the input signal.

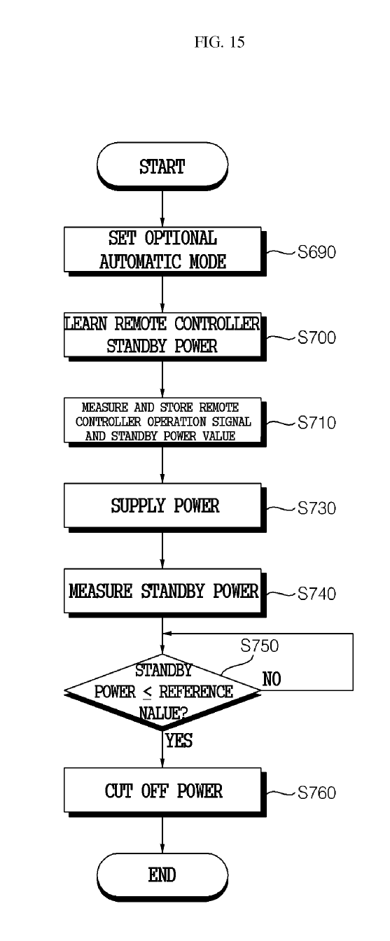

FIG. 15 is a flowchart showing an operation in the optional automatic mode of the plug socket of FIGS. 1 and 3.

As shown in FIG. 15, when the plug socket is set to the optional automatic mode (S690), the control unit 310 controls the learning unit 370 to measure and learn the infrared signal or any other radio signal of the remote controller and the standby power (S700). At this time, the learning unit 370 controls the load current detection unit 410 to measure the load current for a predetermined time, sets the current standby power value as a new reference value, calculates a delay time based on the standby power value, and stores the delay time in the data unit 390 (S710). At this time, the connected electrical device should be in stop and standby modes while the learning unit 370 learns the standby power. This optional automatic mode can be used when the electric power is not automatically cut off since the amount of standby power of the electrical device is greater than the reference value set in the automatic mode or when the electric power is cut off during normal operation since the amount of power consumed during operation of the electrical device is smaller than the reference value of the automatic mode.

When the learning process with respect to the remote controller and the amount of standby power is completed in the above manner, the plug socket is operated in the automatic mode described with reference to FIG. 14. However, the control unit 310 determines whether the electric power is cut off based on a new reference value according to the learned amount of standby power and a new delay time. Moreover, in the same manner as the above-described automatic mode, the infrared signal or any other radio signal of the remote controller can be registered and used, and the registered infrared or radio signal can be used regardless of the mode.

When the electric power is supplied to the electrical device through the plug socket (S730), the load current detection unit 410 measures a load current (S740) and inputs a load signal according to the load current to the control unit 310. Then, the control unit 310 compares the input load signal with a reference value newly set by the learning process and determines the operation state of the electrical device.

When the load signal is less than the newly set reference value (S750), the control unit 310 controls the switch unit 330 to be turned off to cut off the power supply to the electrical device (S760).

When an operation signal is input from the signal input unit 200 while the power supply is cut off, the control unit 310 controls the switch unit 330 to supply the electric power to the electrical device.

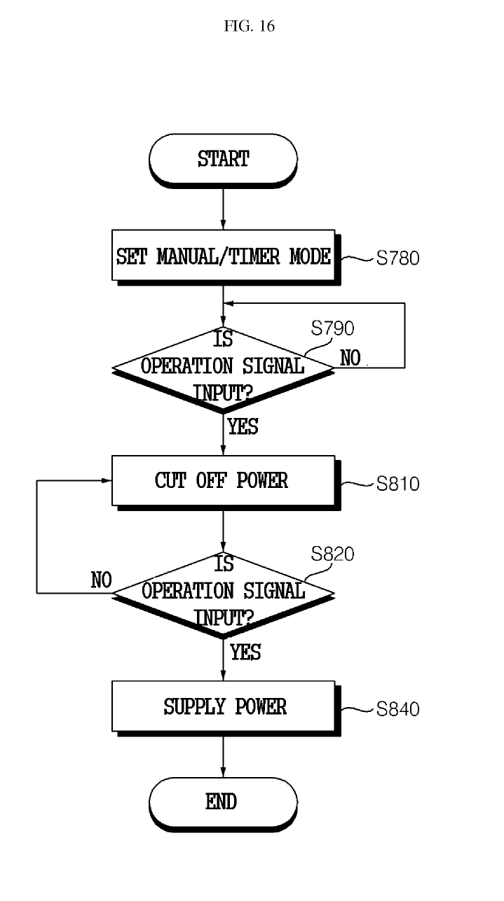

FIG. 16 is a flowchart showing an operation in the manual/timer mode of the plug socket of FIGS. 1 and 3.

Referring to FIG. 16, when the plug socket is set to the manual/timer mode (S780), the control unit 310 supplies or cuts off the electric power in response to an operation signal input from the signal input unit 200 connected to the jack connection unit 420.

At this time, when the operation signal is input from the signal input unit 200 while the electric power is supplied to the electrical device(5790), the control unit 310 controls the switch unit 330 to be turned off to cut off the power supply to the electrical device (S810). In this case, the control unit 310 cuts off the power supply immediately or after a predetermined delay time.

When an operation signal is input from the signal input unit 200 (S820) while the power supply to the electrical device is cut off, the control unit 310 controls the switch unit 330 to be turned on to supply the electric power to the electrical device (S840)

Here, in the case where the signal input unit 200 is the first signal input unit 40, when an operation signal according to the operation of the button of the input unit 42 is input or when the registered infrared or radio signal is input, the control unit 310 recognizes the input signal as an operation signal and controls the switch unit 330 to be switched.

Moreover, when the signal input unit 200 is the second signal input unit 50, the second signal input unit 50 counts the time according to the set time of the timer and applies an operation signal to the control unit 310 after the set time of the timer elapses, and thus the control unit 310 controls the operation of the switch unit 330.

FIG. 17 is a flowchart showing an operation of the second signal input unit connected to the plug socket of FIGS. 1 and 3.

Referring to FIG. 17, when the time input unit 51 of the second signal input unit 50 is operated once, the timer control unit 61 increases the set time of the timer by a predetermined time (S860) and displays the increased time of the timer on the time output unit 52 (S870).

The timer control unit 61 repeats the operation until the timer time setting is completed (S850 to S880). At this time, when the time input unit 51 is not operated for more than a predetermined time, the timer control unit 61 determines that the timer time setting is completed.

When the timer time setting is completed (S880), the timer controller 61 stores the set time of the timer in the timer data unit 62 (S890) and counts the time (S900).

When reaching the set time of the timer (S910), the timer control unit 61 inputs an operation signal to the control unit 310 (S920).

Meanwhile, when the button of the time input unit 51 is pressed for more than a predetermined time (long key input) (S930), the time input unit 51 initializes the set time of the timer and, at the same time, stops the operation of the second signal input unit 50 (S940). When the button of the time input unit 51 is pressed while the operation of the second signal input unit 50, the second signal input unit 50 is re-operated, and the timer time setting becomes available.

Here, during re-operation or during the next timer time setting, the timer control unit 61 reads the last data stored in the timer data unit 62, sets the read data as an initial value, and displays the initial value on the time output unit 52.

Moreover, when the timer time is set to be repeated, the second signal input unit 50 counts the set time of the timer repeatedly and applies an operation signal to the control unit 310 repeatedly. Thus, the electric power to the electrical device or any other plug socket connected to the plug socket is periodically supplied or cut off.

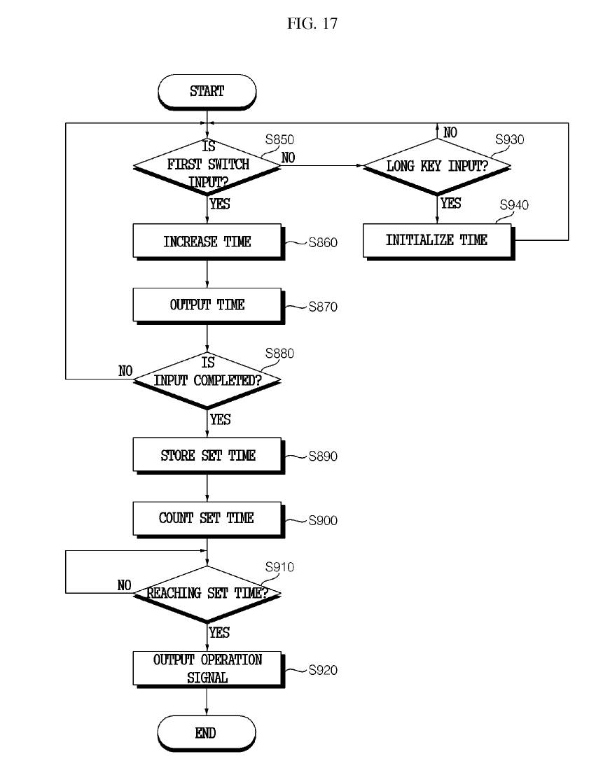

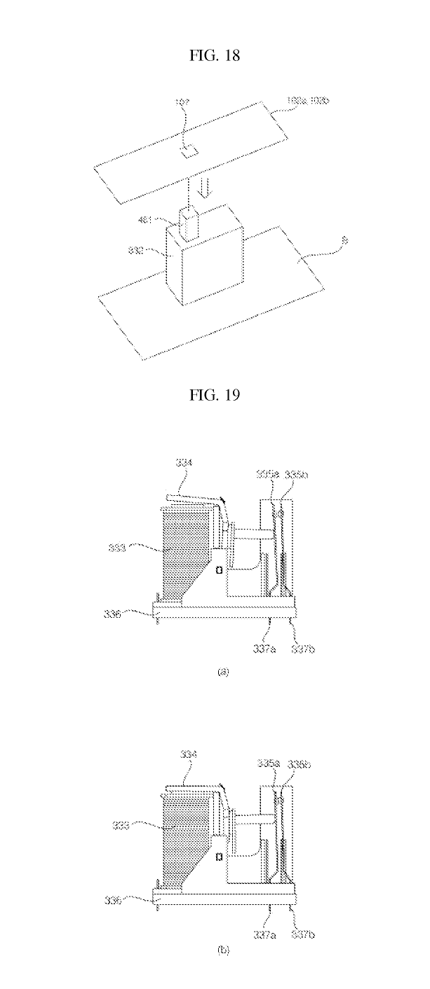

FIG. 18 is a perspective view showing a configuration of a changeover switch unit 460 provided in the plug socket of FIGS. 1 and 3, and FIGS. 19A and 19B are perspective views showing a detailed configuration of the switch unit provided in the plug socket of FIGS. 1 and 3.

As shown in FIGS. 18, 19A, and 19B, the changeover switch 460 is directly connected to the switch unit 330 of the power-saving circuit to forcibly operate the switch unit 330. In this case, the changeover switch unit 460 may include a push button 461.

In the case where the switch unit 330 consists of a relay, when the button 461 of the changeover switch unit 460 is pressed down, the switching structure of the switch unit 330 is forcibly operated, and thus the power supply to the connected electrical device becomes possible.

The changeover switch unit 460 is used to switch the plug socket into the normal power-on mode in the event of malfunction of the power-saving circuit or in the event that there is a problem in using the electrical device as the electric power is not controlled.

When the connection plug 43, 56 of the signal input unit 200 is disconnected from the jack connection unit 420, since the connection between the switch unit 330 and the control unit 310 or the drive circuit 320 is cut off, the switch unit 330 is turned off to cut off the electric power, and thus the plug socket is switched to the power-off mode. In this case, the changeover switch 460 is operated to turn on the switch unit 330 regardless of the control of the control unit 310, thus supplying the electric power. At this time, since the connection between the control unit 310 and the switch unit 330 is cut off and the operation power is not applied to the control unit 310, the plug socket is operated only by the forcible operation of the changeover switch 460.

That is, in the event of circuit failure in the plug socket or in the event that the signal input unit 200 is disconnected from the jack connection unit 420, it is possible to forcibly turn on the switch unit 330 by operating the changeover switch 460, thus switching the plug socket to the normal power-on mode.

The push button 461 of the changeover switch 460 is inserted into a changeover switch insertion hole 107 formed in the socket assembly 102a, 102b and directly connected to the switch unit 330 mounted in circuit board B located inside the socket main body 10, 100a, 100b. Alternatively, the changeover switch unit 460 may include a lever.

As shown in FIG. 19B, the button 461 of the changeover switch unit 460 is connected to a first terminal 334 provided in the switch unit 330 such that, when the button 461 is pressed, the first terminal 334 is forcibly pressed by the button 461 to push a first electrode 335a to be in contact with a second electrode 335b. At this time, the control signal of the drive circuit 320 connected to a first connection terminal 336 is cut off.

The first electrode 335a is connected to a second connection terminal 337a, the second electrode 335b is connected to a third connection terminal 337b, the second connection terminal 337a is connected to the power input terminal, and the third connection terminal 337b is connected to the power output terminal.

As a result, during operation of the changeover switch unit 460, the electrodes of the switch unit are in contact with each other such that the electric power of the power output terminal is supplied to the electrical device through the power output terminal even in the event of failure of the power-saving circuit.

As described above, according to the plug socket of the present invention, it is possible to automatically supply or cut off electric power to the electrical device or any other plug socket connect to the plug socket by detecting a load current of the electric power, thus preventing the waste of standby power and reducing unnecessary power consumption. Moreover, since the electric power is supplied only when the electrical device connected to the plug socket is used, it is possible to prevent electrical accidents, protect the electrical device, and reduce the cost. Although the plugs and the plug sockets used in different countries have different shapes, in the case of the adaptor type plug socket, the socket main body can be used in common, and thus it is unnecessary to manufacture different socket main bodies for different countries.

Moreover, the plug socket according to the present invention can change the method for supplying or cutting off electric power to the electrical device according to the mode selection such that the power supply can be automatically or manually cut off. Furthermore, even in the event of circuit failure in the plug socket or in the event that the signal input unit is disconnected from the jack connection unit, it is possible to forcibly turn on the switch unit by operating the changeover switch, thus switching the plug socket to the normal power-on mode.

When the technique of the present invention is used in the home network system, it is possible to prevent unnecessary power consumption due to communication standby power of about 5 to 10 W consumed even when the communication device is turned off.

Although a few embodiments of the present invention have been shown and described, it would be appreciated by those skilled in the art that changes may be made in this embodiment without departing from the principles and spirit of the invention, the scope of which is defined in the claims and their equivalents.

1. A plug socket comprising:
a power-saving circuit supplying or cutting off electric power to a connected electrical device according to a load current;
a mode setting unit setting any one of an automatic mode, a manual mode, and an optional automatic mode such that the power-saving circuit is operated in the set mode;
a signal input unit connected to a jack connection unit and configured to input an operation signal to supply or cut off electric power to the power-saving circuit; and
a changeover switch unit including a button or a lever to forcibly supply or cut off electric power,
wherein the power-saving circuit comprises:
a switch unit switching the input electric power so that the input electric power is supplied or cut off to the electrical device and cutting off the power supply when the signal input unit is disconnected from the jack connection unit;
a load current detection unit detecting a load current according to an operation state of the electrical device and inputting a load signal; and
a control unit controlling the operation of the switch unit in response to at least one of the mode set by the mode setting unit, the load signal, and the operation signal of the signal input unit.

2. The plug socket of claim 1, wherein when the mode setting unit sets the automatic mode, the control unit controls the power-saving circuit to learn and register an infrared signal or any other radio signal of a remote controller to be used and compares the load signal with a predetermined standby power load value to supply the electric power to the electrical device or cut off after a predetermined delay time.

3. The plug socket of claim 1, wherein when the mode setting unit sets the manual mode, the control unit supplies or cuts off the electric power to the electrical device in response to the operation signal of the signal input unit regardless of the load signal.

4. The plug socket of claim 1, wherein when the mode setting unit sets the optional automatic mode, the control unit controls the power-saving circuit to learn and register an infrared signal or any other radio signal of a remote controller to be used while the power of the electrical device is off, and measures and stores a standby power value of the electrical device through the load current detection unit.

5. The plug socket of claim 4, wherein the control unit sets the measured standby power value and the delay time as a new reference value to determine an operation state of the electrical device, and controls the power supply to the electrical device.

6. The plug socket of claim 2, wherein when the registered infrared or other radio signal is inputted from the signal input unit, the control unit recognizes the inputted signal as an operation signal to control the switch unit and when a signal different from the registered signal is inputted, the control unit ignores the inputted signal.

7. The plug socket of claim 1, wherein the signal input unit comprises:
a connection plug detachably connected to the jack connection unit;
an input unit including at least one button;
a signal receiving unit receiving an infrared signal or any other radio signal transmitted from a remote controller; and
a signal output unit transmitting an operation signal according to an operation of the input unit or the infrared signal or any other radio signal received by the signal receiving unit to the jack connection unit through the connection plug such that an operation signal is applied to the control unit.

8. The plug socket of claim 7, wherein when the input unit is pressed for more than a predetermined time, the signal input unit applies a predetermined signal to the control unit to register an infrared signal or any other radio signal of a specific remote controller, and the controller controls the power-saving circuit to register the infrared signal or any other radio signal according to the predetermined signal.

9. The plug socket of claim 1, wherein the signal input unit comprises:
a connection plug detachably connected to the jack connection unit;
a time input unit including at least one button to input time;
a time output unit displaying the time inputted by the time input unit; and
a timer control unit setting a timer in response to the number of times the time input unit is operated or an operation method thereof and, when reaching a set time of the timer, applying an operation signal to the jack connection unit through the connection plug to be transmitted to the control unit.

10. The plug socket of claim 9, wherein each time the time input unit is operated, the timer control unit increases the set time of the timer in a predetermined time unit and, when reaching a given maximum time, resets the set time of the timer.

11. The plug socket of claim 10, wherein the timer control unit divides the maximum time into a plurality of time frames such that the set time of the timer is increased by a first time unit each time the time input unit is operated in a first time frame, and the set time of the timer is increased by a second time unit each time the time input unit is operated in a second time frame.

12. The plug socket of claim 11, wherein the timer control unit further sets a third time frame and a fourth time frame such that the set time of the timer is increased by a third time unit each time the time input unit is operated in a third time frame, and the set time of the timer is increased by a fourth time unit each time the time input unit is operated in a fourth time frame.

13. The plug socket of claim 9, wherein when the button of the time input unit is pressed for more than a predetermined time or is continuously pressed in a predetermined time unit, the timer control unit initializes the set time of the time or terminates the operation of the signal input unit.

14. The plug socket of claim 9, wherein when the timer control unit is restarted upon normal termination of the timer, the timer control unit sets the last set time of the timer as an initial value and, when the button of the time input unit is further pressed, changes the set time of the timer.

15. The plug socket of claim 9, wherein the signal input unit further comprises a repetitive mode setting unit setting the set time of the timer to be repeatedly counted, and
wherein when a repetitive mode is set by the repetitive mode setting unit, the timer control unit counts the time in each period of the set time of the timer and, when reaching the set time of the timer, repeatedly applies an operation signal to the plug socket.

16. The plug socket of claim 1, further comprising a power switch unit directly connected to the switch unit to forcibly operate the switch unit in response to an operation state such that the switch unit is turned on regardless of a control command of the control unit, thus supplying the electric power to the electrical device.

17. A plug socket comprising:
an adaptor type socket main body in which a power-saving circuit is mounted to cut off electric power supplied to a connected electrical device;
a first connection unit including a first connector connected to one side of the socket main body and a second connector having a shape different from that of the first connector and supplying external power to the socket main body;
a connection plug detachably connected to the socket main body; and
a signal input unit inputting an operation signal to the socket main body to supply or cut off electric power to the electrical device.

18. The plug socket of claim 17, further comprising a second connection unit including a third connector having the same shape as the first connector and a fourth connector having the same shape as the second connector and connected to the socket main body through the third connector to supply electric power to an electrical device connected to the fourth connector.

19. A plug socket comprising:
a built-in type socket main body in which a power-saving circuit is mounted to cut off electric power supplied to a connected electrical device;
a first power connection portion provided on a rear surface of the socket main body and connecting external power to the power-saving circuit such that electric power is supplied to the power-saving circuit;
a second power connection portion connecting the power-saving circuit to external power; and
a power-line disconnecting and fixing portion fixing a power line inserted into the first power connection portion and the second power connection portion in a first state and opening the first power connection portion and the second power connection portion such that the power line inserted and fixed to the first power connection portion and the second power connection portion is separated in a second state.

20. The plug socket of claim 4, wherein when the registered infrared or other radio signal is inputted from the signal input unit, the control unit recognizes the inputted signal as an operation signal to control the switch unit and when a signal different from the registered signal is inputted, the control unit ignores the inputted signal.
